(19) United States
(12) Patent Application Publication
(10) Pub. No.: US 2014/0283106 A1
(43) Pub. Date: Sep. 18, 2014

(54) DOMAIN PROTECTED MARKS LIST BASED TECHNIQUES FOR MANAGING DOMAIN NAME REGISTRATIONS

(71) Applicant: DONUTS INC., Bellevue, WA (US)

(72) Inventors: Paul Stahura, Sammanish, WA (US); Richard Tindal, Bellevue, WA (US)

(73) Assignee: DONUTS INC., Bellevue, WA (US)

(21) Appl. No.: 13/804,919

(22) Filed: Mar. 14, 2013

(51) Int. Cl. G06F 21/10

(52) U.S. Cl. CPC G06F 21/10
USPC 726/27

(57) ABSTRACT

A facility comprising systems and methods for preventing or protecting against the registration of domain names that exactly match, contain, or are similar to a mark is provided. The facility maintains a data structure for recording strings that an entity, such as an individual, company, or other organization, has an interest in protecting, such as a domain name that exactly matches, contains, or is similar to a mark owned or held by the entity. In response to requests to register a domain name that includes a recorded string, the facility can prevent registration of that domain name even if the domain name is not registered. The facility may periodically share or publish the data structure with any number of domain name registrars or registries. In this manner, a mark holder can prevent or protect against registration of domain names under any number of top-level domains with a single request.

### BACKGROUND

The Internet connects computers, computer networks, and users throughout the world. Computing resources, such as web servers, connected to the Internet are each assigned an Internet Protocol (“IP”) address that represents the online “location” of that resource. IP addresses, which are defined by a set of numeric values (e.g., 135.54.148.32 (IPv4) or 5031:ad53:4be4:d3e4:c940:132f:d189:145d (IPv6)), are often difficult for humans to remember. Domain names, such as “acme.com” or “acme.net,” which are often easier for humans to remember, provide a convenient alternative to IP addresses. Rather than remembering and entering an unremarkable string of numbers to access a website, a user can simply enter a corresponding domain name. A domain name is a string of characters (e.g., numbers or letters) specifying a top-level domain (“TLD”) (e.g., .com, .net, .org) and one or more sub-domains. For example, “acme.com” comprises the sub-domain (or sometimes called the second-level domain or “SLD”) “acme” (which is itself comprised of a string of characters, or sometimes called simply a “string”) under the TLD “.com.”

Domain name registries (e.g., Verisign, Inc.) are entities that manage or operate TLDs. In some cases, registries interact directly with domain name applicants, or registrants, who wish to register domain names. Typically, however, domain names are registered through registrars, which may be accredited by the Internet Corporation for Assigned Names and Numbers, or “ICANN.” Each registry maintains databases of currently-registered domain names, each database identifying the SLDs that are registered in a corresponding TLD, who holds the registration, and other identifying information. When a party wishing to register a domain name submits a corresponding request, the registrar submits the request to the relevant registry. If the domain name is not then currently registered, the registry typically allows the domain name to be registered to the first requesting party. As an alternative to this “first-come, first-serve” system, registries may auction domain names, use “sunrise periods” (during which qualified claimants with certain rights to marks, such as a trademark, are offered preferential registration rights), and/or offer rights of first refusal. Currently, ICANN controls the addition of new TLDs to the root domain name server. In 2011, ICANN voted to end most restrictions on top-level domain names and allow companies or other organizations to apply for new TLDs. ICANN began taking applications for the new TLDs in early 2012 and has received over 1,900 applications for new TLDs, such as “.app,” “.blog,” “.book,” “.shop,” and so on, and expects to begin activating these TLDs in 2013.

Domain names are important for mark holders, such as holders of registered or non-registered trademarks or service marks. Registering domain names that contain a mark allows the mark holder to take advantage of the goodwill of their mark in the digital world. The relatively open domain name registration process, however, sometimes presents problems for mark holders. Cybersquatting, for example, is an act of registering or using a domain name in bad faith for the purpose of unduly extracting money or other resources from the mark holder and/or the public. For example, a cybersquatter may intentionally register a domain name based on another party's registered mark and hold the domain name ransom. As another example, a party may register a domain name that is similar to a registered trademark and use the registered domain name to exploit the goodwill of the registered trademark. One such act, known as “typosquatting,” involves registering a domain name that is a misspelling of another domain name (e.g., “akme.com” or “adme.com” as a misspelling of “acme.com”) in the hope that an unsuspecting user (and potential customer of “acme.com”) will inadvertently visit the typosquatter's website. The typosquatter's website may include annoying advertisements, pop-ups, or offensive material and discourage the user from visiting and/or conducting business with acme.com. In addition to cybersquatting, domain name registrants can employ other techniques to leverage the goodwill of the mark and/or disparage the mark holder, such as registering the domain name “acme-sucks.com” or “acmesux.org” and/or using an alternative alphabet, such as leet or leetspeak, or Internet slang in a domain name, and so on.

To help combat cybersquatting, ICANN established the Uniform Domain-Name Dispute-Resolution Policy (“UDRP”) in 1999. The UDRP provides procedures for resolving disputes over domain name registrations. The UDRP procedures, however, can be expensive and time consuming. There are also existing laws in the US prohibiting cybersquatting and imposing penalties on perpetrators. In some cases, mark holders have found it less expensive to simply pay a cybersquatter for a domain name as opposed to invoking the UDRP or pursuing legal action. It is desirable to create a cost- and time-effective way to protect mark holders from the acts of cybersquatters who want to exploit mark holders through domain name registrations.

### BRIEF DESCRIPTION OF THE DRAWINGS

FIG. 1 is a block diagram illustrating an environment in which a facility in accordance with an embodiment of the disclosed technology may operate.

FIG. 2 is a flow diagram illustrating the processing of an add string component in accordance with an embodiment of the disclosed technology.

FIG. 3 is a flow diagram illustrating the processing of a bypass component in accordance with an embodiment of the disclosed technology.

FIG. 4 is a flow diagram illustrating the processing of a generate token component in accordance with an embodiment of the disclosed technology.

FIG. 5 is a flow diagram illustrating the processing of a register component in accordance with an embodiment of the disclosed technology.

### DETAILED DESCRIPTION

A facility comprising systems and methods for preventing or protecting against the registration of domain names that exactly match, contain (e.g, partially match), or are similar to a mark is provided. The facility maintains a data structure, herein referred to as a Domain Protected Marks List (“DPML”), for recording strings that an entity (e.g., an individual, company, or other organization) has an interest in protecting, such as a domain name that contains or is similar to a mark owned or held by the entity. The facility is part of a DPML system configured to prevent or protect against the registration of domain names that exactly match, contain (e.g., partially match), or are similar to a mark by entities that do not hold the mark (or similar marks). For example, Acme Corporation may have a trademark related to the term “acme.” Additionally, Acme Corporation may have registered “acme.com,” “acme-corp.com,” and other domain names that Acme Corporation uses to serve one or more websites or to send and receive email, for example. Acme Corporation, however, may have no interest in serving, or having others serve, websites under other TLDs via domain names that include the term “acme,” such as “acme.blog,” “acme.app,” “acme.book,” “acme-corp.web,” and so on. The facility allows Acme Corporation to record strings, such as “acme” or “acme-corp,” in a DPML and uses these recorded strings to block or prevent others from registering domain names that include those strings. Thus, if an entity, that does not also hold a mark such as “acme” or “acme-corp,” attempts to register “acme.biz,” “acme.school,” “acme-sucks.biz,” “acme-corp-sucks.info,” “acme-corp.web,” and so on, the facility can prevent the entity from registering these domain names based on Acme Corporation's previously-recorded entries (“acme” and “acme-corp”) in the DPML even if the domain names are not registered with a domain name registry. In other words, in response to requests to register a domain name that includes a string recorded in the domain protected marks list, the facility can prevent registration of that domain name. In this manner, a mark holder can prevent or protect against the registration of domain names—across multiple TLDs—that match, include, or are similar to the mark holder's mark with a single request to the DPML system, thereby saving the mark holder substantial time. Moreover, because updating the DPML does not require individual domain name registration requests (and payments) for each or any of the protected domain names (one for each participating TLD, such as acme.shoe, acme.blog, acme.sports, acme.book, etc.), and the DPML would typically be cheaper than a registration on a per-TLD basis, the mark holder can also realize a substantial cost savings. Also, the registry benefits because the block does not block other mark holders from registering their marks as domain names and thus allows the registry to charge full-registration price to those other mark holders. The other mark holders benefit by still being allowed to register those domain names (if not already registered). Furthermore, a DPML service may include multiple domain name registrars and registries that each share and publish DPML updates and use the DPML to block registrations in their respective TLDs, offering the mark holder protection across any number of registrars and registries with a single request.

In some embodiments, each entry in the DPML comprises a “prefix string,” a “mark string,” and a “suffix string” and the facility is configured to allow mark holders with marks that match the “mark string” to record corresponding entries in the DPML. Subsequent attempts to register domain names that begin with the prefix string, contain the mark string, and end in the suffix string can be blocked based on the DPML. For example, Acme Corporation may record an entry in the DPML comprising “acme” as the “mark string,” “-sucks” as the suffix string, and a blank prefix string (concatenated together the resulting string is therefore “acme-sucks”). Attempts to register second level domain names in a participating TLD that exactly match “acme-sucks” (e.g., “acme-sucks.shoe” or “acme-sucks.app”) can be blocked based on Acme's recorded entry in the DPML. A blank prefix string or suffix string can be matched to any text such that a DPML entry that includes the mark string “acme,” a blank prefix string, and a blank suffix string (concatenated results in the string “acme”) will exact-match to any “acme” SLD registration, and therefore it will be blocked from registration. Thus, the DPML system may block any attempt to register a domain name that exactly-matches or contains “acme.”

In some embodiments, the facility may use mark data or mark information provided by a trusted mark registry to verify or authenticate an entity requesting to add an entry to the DPML, or it may validate or authenticate the entity itself by, for example, requiring secure or tamper-resistant authentication information, etc. For example, the facility may query a trademark office, such as the United States Patent and Trademark Office or the European Union's Office for Harmonization in the Internal Market, to determine whether the requesting entity actually owns a trademark that matches (e.g., exactly or partially) a string that the requesting entity wishes to add to the DPML, and the facility may perform other checks (potentially offline checks) to validate that the requesting entity is actually the entity they claim to be. As another example, the facility may receive, in conjunction with the request, a Signed Mark Data (“SMD”) file provided by a mark clearinghouse or mark registry, such as ICANN's Trademark Clearinghouse. ICANN's Trademark Clearinghouse was established to assist with authentication and verification of trademark owners or holders and their marks. A trademark holder may submit trademark data to the Trademark Clearinghouse and, if the Trademark Clearinghouse verifies that the submitter owns the trademark and the submitter is who they purport to be, receive from the Trademark Clearinghouse a digitally signed SMD file. The SMD file specifies, among other things (such as whether the mark is or is not an “in-use” mark), a number of domain labels, each domain label including a corresponding string for which the trademark owner may have an interest in registering as a domain name within one or more TLDs. For example, an SMD file for BARNES AND NOBLE may include domain labels corresponding to: “barnesandnoble,” “barnes-noble,” “barnes-and-noble,” “barnesnoble,” and so on. Additional information regarding ICANN's Trademark Clearinghouse can be found at http://newgtlds.icann.org/en/about/trademark-clearinghouse. Mark data provided by a trusted entity allows the facility to more easily verify and authenticate mark owners and their marks in order to add an entry to or otherwise update the DPML (e.g., by renewing or removing a DPML entry). In some embodiments, the DPML system may maintain its own mark registry as a list of marks and associated information, such as who owns the mark, where the mark is in use and/or registered, status of the mark, and so on. Accordingly, the mark registry may including information about marks that are not registered with a trademark granting body, such as the United States Patent and Trademark Office, the Canadian Intellectual Property Office, and so on. In some embodiments, the facility may use other data in the SMD file (or which may be obtained by other means) to differentiate between in-use marks (for example for USPTO marks) and non-in-use marks (which some trademark offices allow), and, for example, allow in-use marks or corresponding strings to be entered in the DPML and prevent non-in-use marks or corresponding strings from being entered in the DPML.

In some embodiments, the facility provides a mechanism for protecting against the registration of domain names that do not exactly match or contain a requesting entity's trademark but that may cause damage to the entity holding the mark if registered to malicious users. For example, even though Acme Corporation may not have trademarked “accme” or “akme,” Acme Corporation may wish to prevent others from registering these typo domain names to avoid typosquatters from registering domain names hoping to lure unsuspecting users to their sites. To protect these domain names against registration, the facility provides a bypass mechanism through which entities may take advantage of the DPML even if they do not own a mark that at least partially matches the string (or strings) they wish to protect. To take advantage of the bypass mechanism, a party can submit a request for a DPML authorization token, the request including mark data (e.g., an SMD file) and a string or set of strings. For each string, the facility determines, based on the mark data, whether the string is similar enough to a protected mark or is likely to be easily confused with the mark or otherwise harm the mark holder. For example, the facility may calculate a distance (e.g., Levenshtein distance) between the string and a domain label specified in an SMD. As another example, the facility may submit the string and domain labels to a human for a determination of whether the string is similar to a protected mark or is likely to be confused with the mark or likely damage its holder. If the string is similar to a protected mark or is likely to cause harm, the facility can issue a DPML authorization token that the requester can then use to record an entry in the DPML. Accordingly, a string need not match a mark exactly to be qualified for entry in the DPML.

In some embodiments, the facility may allow an entity to register a domain name even though the DPML includes an entry specifying a string corresponding to the domain name (i.e., a string that matches the sub-domain of the domain name). In other words, the facility provides a mechanism for overriding the DPML in certain cases. For example, if the requesting entity also recorded the string in the DPML, the facility may allow the entity to “override” the DPML entry and register a corresponding domain name. Using the example above, Acme Corporation may, after recording “acme” in the DPML, wish to register the domain name “acme.biz,” and that it holds a mark for “acme.” In response to verifying that Acme Corporation has submitted a request to register “acme.biz,” the facility can override the DPML and authorize registration of the domain name. In some cases, an entity may be charged an “override” fee for overriding the DPML. As another example, if the entity requesting registration also owns a trademark related to a string in the DPML, the facility may allow the requesting entity to override the DPML. For example, two parties may own the same mark in different jurisdictions or in different mark classifications. As another example, Delta Air Lines, Inc. and Masco Corporation each own trademarks related to the word “Delta.” Thus, each may be interested in registering and/or protecting against the registration of domain names that include the word “Delta.” If Delta Air Lines has recorded “Delta” in the DPML, the facility may allow Masco, upon proving that it owns or has rights in a mark related to “Delta” and is requesting registration of a domain name having a portion that exactly matches “Delta” (not case-sensitive) such as delta.faucets or delta.water, to override the DPML and register the domain name. As another example, Citibank, may record an entry in the DMPL corresponding to the string “citizen” based on Citibank's trademark on the word “citi.” Subsequently, Citizen Watch Company may wish to register the domain name “citizen.watch”. Citizen's registration request would override the block if Citizen proved to the facility (typically accomplished by presenting, directly or indirectly, the SMD file) that it is in fact Citizen Watch Company and it holds a mark corresponding to “citizen.” Accordingly, the facility can override the DPML to allow a mark holder to register a domain name even though the DPML contains an entry corresponding to the domain name (e.g., the sub-domain of the domain name matches the DPML entry's string) recorded by another entity. Potential registrants that do not own a corresponding mark, however, will still be prevented from registering conflicting domain names (i.e., domain names that correspond to a string in the DPML). Accordingly, a mark holder can protect their mark against others but not necessarily against others with the same mark.

As another example, the facility may maintain a list of “premium domain names” on a per-TLD basis such as domain names that contain fewer than three letters or characters in the sub-domain (e.g., “a1.restaurant” or “LOL.book”) or domain names containing specified strings, such as “blog” as in “blog.sport” or “blog.soccer” or are related to the TLD (e.g., “apple.fruit”, “ford.family” or “blue.car” or “paul.name”, apple, ford, blue, and paul all being registered trademarks), or other names. In response to receiving a request to register an unregistered, premium domain name, the facility may authorize the registration regardless of the contents of the DPML.

FIG. 1 is a block diagram illustrating an environment 100 in which a facility in accordance with an embodiment of the disclosed technology may operate. In this example, the environment 100 includes domain registry computers 110, comprising facility 120, trademark registry computers 130, domain name registrar computers 140, and applicant computers 150. Domain name registrar computers 140 process domain name registration requests, DPML requests, etc. Mark registry computers 130 maintain information about registered marks, verify or authenticate mark holders, and provide signed data that can be used to authenticate mark holders. Domain name registry computers 110 maintain databases of currently-registered domain names within one or more TLDs and process domain name registration and DPML requests. Applicant computers 150 submit, for example, domain name registration requests and/or DPML requests on behalf of an entity or domain name applicant. Facility 120 comprises an add string component 121, a bypass component 122, a generate token component 123, a register component 124, a data store 125, and a DPML 126. Add string component 121 is invoked to add an entry (and corresponding string) to a DPML data structure. By pass component 122 is invoked by the add string component to determine whether a received string can be added to the DPML based on a DPML authorization token. Generate token component 123 is invoked to generate a DPML authorization token that can be used to record a string with the DPML for a mark that does not at least partially match the string to be recorded. Register component 124 is invoked to authorize registration of a domain name. Data store 125 stores information about the DPML system, such as TLDs, registrars, registrants, the term of the DPML entry (renewal date, etc.) and/or registries participating in the DPML system, tokens that have been issued or that have been used, and so on. DPML 126 stores a plurality of entries, each entry comprising a string that is to be protected during domain name registrations and additional information, such as when the entry was recorded, when the entry expires, who created or requested creation of the entry, and so on. Although in this example the facility is shown as part of the domain registry computers 110, the facility or various components thereof may reside at other computers, such as domain name registrar computers 140. In some embodiments the computers and various components communicate via network 160 or directly via wired or wireless communication connections (e.g., radio frequency, WiFi, bluetooth).

The computing devices on which the disclosed systems are implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the technology, e.g., a computer-readable medium that contains the instructions. In addition, the instructions, data structures, and message structures may be stored or transmitted via a data transmission medium, such as a signal on a communications link and may be encrypted. Non-transitory computer-readable media include tangible media such as storage media, hard drives, CD-ROMs, DVD-ROMS, and memories such as ROM, RAM, and Compact Flash memories that can store instructions. Signals on a carrier wave such as an optical or electrical carrier wave are examples of transitory computer-readable media. Various communications links may be used, such as the Internet, a local area network, a wide area network, a point-to-point dial-up connection, a cell phone network, and so on.

The disclosed systems may be described in the general context of computer-executable instructions, such as program modules, executed by one or more computers or other devices. Generally, program modules include routines, programs, objects, components, data structures, and so on, that perform particular tasks or implement particular abstract data types. Typically, the functionality of the program modules may be combined or distributed as desired in various embodiments.

Many embodiments of the technology described herein may take the form of computer-executable instructions, including routines executed by a programmable computer. Those skilled in the relevant art will appreciate that aspects of the technology can be practiced on computer systems other than those shown and described herein. Embodiments of the technology may be implemented in and used with various operating environments that include personal computers, server computers, handheld or laptop devices, multiprocessor systems, microprocessor-based systems, programmable consumer electronics, network PCs, minicomputers, mainframe computers, computing environments that include any of the above systems or devices, and so on. Moreover, the technology can be embodied in a special-purpose computer or data processor that is specifically programmed, configured or constructed to perform one or more of the computer-executable instructions described herein. Accordingly, the terms “computer” or “system” as generally used herein refer to any data processor and can include Internet appliances and handheld devices (including palmtop computers, wearable computers, cellular or mobile phones, multi-processor systems, processor-based or programmable consumer electronics, network computers, mini computers and the like). Information handled by these computers can be presented at any suitable display medium, including a CRT display or LCD.

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the technology. For example, various systems may transmit data structures and other information using various protocols, such as the hypertext transfer protocol (HTTP), the transmission control protocol (TCP), the extensible provisioning protocol (EPP), and so on.

FIG. 2 is a flow diagram illustrating the processing of an add string component in accordance with an embodiment of the disclosed technology. The add string component is invoked to add an entry and corresponding string to a domain protected marks list data structure. In block 205, the component receives the string from, for example, a domain registrant or domain registrar computer. The request may be received via the Extensible Provisioning Protocol (EPP) or other standard protocols. In block 210, the component receives mark data specifying one or more marks and strings related to those marks, such as domain labels. In decision block 215, if the mark data is valid, then the component continues at block 220, else the component continues at block 240. The component may validate the mark data by, for example, determining whether the mark data was signed by a trusted mark registry and/or the owner of the mark corresponding to the mark data. One skilled in the art will recognize that the component may employ any number of encryption and authentication schemes, such as tamper-resistant public-key cryptography, and so on to validate and authenticate the mark data. In decision block 220, if the received string matches (e.g., partially or exactly) a string associated with or included with the mark data (e.g., domain labels), then the component continues at block 235, else the component continues at block 225. For example, if the received string is “acme” and the mark data includes the string “acme” (an exact match) or “acme-sucks” (a non-exact match), sometimes referred to as a “contains match,” then the component may continue at block 235. If, however, the received string is “accme” or “akme” and the mark data only identifies the string “acme,” then the component may continue at block 225. In some embodiments, decision block 220 may require an exact match while in other embodiments decision block 220 may permit exact or partial matches. In block 225, the component invokes a bypass component to determine whether the requesting party is authorized to record the received string in the DPML. In decision block 230, if the requesting party is authorized to record the received string in the DPML, then the component continues at block 235, else the component continues at block 240. In block 235, the component updates the DPML and then completes. The component may update the DPML by, for example, adding an entry to the DPML specifying the received string, an indication of the requesting entity, an indication of an associated expiration date (e.g., 1, 5, 10 years from recordation), and so on. In some embodiments, the component may record separate entries for each top-level domain for which protection is requested or permitted. The TLD names may be specified by the requesting entity as part of the request or may be determined by the component based on TLDs participating in the DPML service. In block 240, the component denies the request without modifying the DPML and then completes. In some embodiments, the component may perform additional steps, such as calculating and assessing a fee for each entry added to the DPML and/or submitting the updated DPML to a number of domain name registrars and/or registries. Additionally, the component may append a “DPML suffix” to the string, such as “ml.zone,” and submit the appended string to a Domain Name System (DNS) server along with associated WHOIS information (RFC 3912) to a whois server. In this manner, DNS servers can be queried (privately or publicly) to determine whether or not a particular string is on the DPML and whois servers can be queried to determine which entity created the DPML.

FIG. 3 is a flow diagram illustrating the processing of a bypass component in accordance with an embodiment of the disclosed technology. The bypass component is invoked by the add string component to determine whether a received string can be added to the DPML using a DPML authorization token. In block 310, the component receives the DPML authorization token. The DPML authorization token may have been generated using a generate token component discussed below with respect to FIG. 4. In decision block 320, if the DPML authorization token is valid, then the component continues at block 330, else the component returns a failure message indicating that the requesting party is not authorized to record the received string. In decision block 330, if the received string identically matches a string specified by the DPML authorization token, then the component continues at block 340, else the component returns a failure message indicating that the requesting party is not authorized to record the received string. In block 340, the component flags the DPML authorization token or a related data store to indicate that the DPML authorization token can no longer be used to record entries in the DPML and then returns a success message indicating that the requesting party is authorized to record the received string.

FIG. 4 is a flow diagram illustrating the processing of a generate token component in accordance with an embodiment of the disclosed technology. The generate token component is invoked to generate a DPML authorization token that can be used to record a string with the DPML for a mark that does not at least partially match the string to be recorded. For example, Acme Corporation may request a DPML authorization token to record “accme” or “akme” if Acme Corporation does not have a trademark that at least partially matches “accme” or “akme.” In block 410, the component receives the string that the requesting entity desires to record in the DPML. In block 420, the component receives mark data, such as an SMD file. In block 430, the component assesses the string by, for example, comparing the string to one or more strings of the received mark data and/or receiving, from a DPML administrator or other user, an indication of whether the received string is suitable for recordation. In decision block 440, if the string is authorized to be recorded, then the component continues at block 450, else the component completes. In block 450, the component creates the DPML authorization token at least in part by digitally signing the received string. In some examples, the DPML authorization token may include additional information, such as an expiration date, an indication of the requesting party, an indication of the authorizing entity, and so on. In block 460, the component sends the token to the requesting party and then completes.

FIG. 5 is a flow diagram illustrating the processing of a register component in accordance with an embodiment of the disclosed technology. The register component is invoked to authorize registration of a domain name based on a DPML. In block 510, the component receives a domain name, such as “acme.web,” that a requesting entity is attempting to register. In decision block 520, if the domain name is already registered or otherwise reserved, then the component completes without registration of the domain name, else the component continues at decision block 530. In decision block 530, if the domain name is a premium domain name, then the component continues at block 590 to authorize registration of the domain name and then completes, else the component continues at decision block 540. In decision block 540, if the domain name matches an entry in the DPML, then the component continues at decision block 550, else the component continues at decision block 590 to authorize registration of the domain name and then completes. In decision block 550, if the request includes verified mark data (or if the requesting party otherwise provides mark data that can be verified, such as in response to a request for such data), then the component continues at decision block 560, else the component completes without registration. In decision block 560, if the request is received from the entity that recorded the matching DPML entry, then the component continues at block 580, else the component continues at decision block 570. In block 580, the component assesses an optional fee to the requester for overriding or “piercing” the DPML. The optional fee may be a flat fee, a fee that escalates (or decreases) with each override, a fee that is based at least in part on the domain name to be registered, and so on. In some embodiments, the component may track the number of times that a particular string was blocked from registration by the DPML and charge an optional fee that increases with each block. In decision block 570, if the received domain name matches (e.g., partially or exactly) a string specified by the received mark data, then the component continues at block 590 to authorize registration of the domain name and then completes, else the component completes without registration of the domain name.

Those of ordinary skill in the art will recognize that while the disclosed techniques are generally discussed in the context of registries, registrars, and the public or quasi-public TLDs administered by ICANN and other bodies, the disclosed techniques can be applied to analogous applications in the field of domain name and IP address systems, such as a privately managed domain name systems and/or computer networks. In this case, a “registry” is any person or entity with authoritative control over a hierarchical domain or IP address or other computer address system; and in which case a “registrar” is a delegate of the “registry” with authoritative control over one or more levels of sub-domains or sub-addresses; and in which case a “registrant” is a delegate of the “registrar” with authoritative control over one or more levels of sub-domains or sub-addresses below the level of the “registrar.”

From the foregoing, it will be appreciated that specific embodiments of the technology have been described herein for purposes of illustration, but that various modifications may be made without deviating from the disclosure. The facility can include additional components or features, and/or different combinations of the components or features described herein. For example, the disclosed facility may determine and assess fees (and associated grace period) for various acts, such as generating a DPML authorization token, overriding the DPML to register a DPML-protected domain name, deleting or removing a DPML entry, and so on. Moreover, although the DPML data structure is herein described as a list, one of ordinary skill in the art will recognize that the DPML information may be stored in any number of data structures, such as a table or an array. As another example, one or more computer memories may collectively contain a marks list data structure relating to a plurality of strings that are each protected from being registered as domain names within a plurality of top-level domains, the data structure comprising a plurality of entries, each entry containing a string and identifying a mark, such that each entry can be used to determine whether a request to register a domain name within any one of the plurality of top-level domains should be denied. In some embodiments, the DPML system maintains a shadow or non-public registry containing the DPML. Each entry in the shadow or non-public registry includes a string and domain names containing that string can be blocked from registration by the DPML system. Moreover, domain name registries may query the shadow registry (via standard interfaces, such as EPP, and so on) to identify blocked domain names, to make entries in the DPML, to determine whether a request to register a domain should be authorized or denied, and so on. In some embodiments, multiple registries may maintain separate DPML systems. Additionally, while advantages associated with certain embodiments of the new technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method, performed by a computing system having a processor, for managing domain names, the method comprising:
receiving a first request to prevent, across a plurality of top-level domains, registration of domain names at least partially matching a string specified by the first request, the first request including mark information for at least one mark registered with a mark registry;
determining whether the first request was received on behalf of a holder of the at least one mark;
in response to determining that the first request was received on behalf of a holder of the at least one mark and that the mark information includes at least one string that at least partially matches the string specified by the first request,
updating a domain protected marks list to include an entry for the string specified by the first request so that attempts to register a domain name containing the string specified by the first request can be blocked; and
receiving a second request to register a first domain name,
in response to determining that the domain protected marks list contains an entry at least partially matching the first domain name, denying the second request.

2. The method of claim 1, further comprising:
receiving a third request to register the first domain name, the third request including mark information,
determining whether the third request was received on behalf of a holder of the at least one mark, and
in response to determining that the third request was received on behalf of a holder of the at least one mark and that the mark information included with the third request includes a string that at least partially matches the first domain name,
authorizing the third request to register the first domain.

3. The method of claim 1 wherein the first request includes mark information provided by a mark registry, the mark information specifying a plurality of strings, and wherein determining whether the first request was received on behalf of a holder of the at least one mark comprises determining whether the mark information is digitally signed by the mark registry.

4. The method of claim 3 wherein the mark information comprises a signed mark data (SMD) file issued by the Trademark Clearinghouse of the Internet Corporation for Assigned Names and Numbers.

5. The method of claim 3, further comprising:
receiving a request for an authorization token, the request for the authorization token specifying a string and mark information,
determining, based at least in part on the string and mark information specified by the request for the authorization token, whether the string specified by the request for the authorization token can be added to the domain protected marks list, and
in response to determining that the string specified by the request for the authorization token can be added to the domain protected marks list,
generating an authorization token based at least in part on the string specified by the request for the authorization token.

6. The method of claim 5, further comprising:
in response to determining that the string specified by the first request does not identically match at least one of the plurality of strings specified by the mark information,
determining whether the first request specifies an authorization token generated based at least in part on the string specified by the first request, and
in response to determining that the first request specifies an authorization token generated based at least in part on the string specified by the first request, updating the domain protected marks list to include an entry for the string specified by the first request.

7. The method of claim 1 wherein the first request and the second request are received by a domain name registry.

8. The method of claim 7 wherein the first request and the second request are received via the extensible provisioning protocol as a standard domain name registration requests.

9. The method of claim 1 wherein the first request is received by a first domain name registry and wherein the second request is received by a second domain name registry other than the first domain name registry.

10. The method of claim 1 wherein the first domain name registry manages the domain protected marks list and does not manage a top-level domain and wherein the second domain name registry manages a top-level domain.

11. The method of claim 1 wherein the at least one mark is a registered trademark.

12. The method of claim 1 wherein the at least one mark is a registered service mark.

13. The method of claim 1, further comprising:
publishing the updated domain protected marks list to a plurality of domain name registries.

14. The method of claim 1 wherein determining whether the first request was received on behalf of a holder of the at least one mark comprises querying a trademark office.

15. The method of claim 1 wherein the trademark office is at least one of the United States Patent and Trademark Office and the European Union's Office for Harmonization in the Internal Market.

16. A computer-readable storage medium storing instructions that, if executed by a computing system having a processor, cause the computing system to perform operations comprising:
receiving a first request to prevent registration of domain names at least partially matching a string specified by the first request, the first request including a signed mark data file received from the Trademark Clearinghouse of the Internet Corporation for Assigned Names and Numbers;
determining whether the signed mark data file is valid; and
in response to determining that the signed mark data file is valid,
determining whether at least one string specified by the signed mark data file matches the string specified by the first request, and
in response to determining that at least one string specified by the signed mark data file matches the string specified by the first request,
updating a domain protected marks list maintained by the domain name registry to include an entry for the string specified by the first request.

17. The method of claim 16, the operations further comprising:
sending the updated domain protected marks list to another domain name registry so that requests to register a domain name that at least partially matches the string specified by the first request can be denied.

18. The method of claim 16 wherein the sending is performed in accordance with at least one of the extensible provisioning protocol and the domain name system protocol.

19. The computer-readable storage medium of claim 16, the operations further comprising:
maintaining, for each of a plurality of top-level domains, a list of premium domain names.

20. The computer-readable storage medium of claim 19, the operations further comprising:
receiving a second request to register an unregistered first domain name containing the string specified by the first request, the second request including a signed mark data file,
in response to determining that the unregistered first domain name is a premium domain name, authorizing registration of the unregistered first domain name with a domain name registry without accessing the domain protected marks list, and
in response to determining that the unregistered first domain name is not a premium domain name,
determining whether the signed mark data file received with the second request is valid and contains a string that at least partially matches the string specified by the first request,
in response to determining that the signed mark data file received with the second request is valid and contains a string that matches the string specified by the first request, authorizing registration of the unregistered first domain name with a domain name registry, and
in response to determining that the signed mark data file received with the second request is not valid or does not contain a string that at least partially matches the string specified by the first request, denying registration of the unregistered first domain name with a domain name registry.

21. The computer-readable storage medium of claim 16, the operations further comprising:
receiving, from a domain name registry, a domain protected marks list; and
storing the received domain protected marks list.

22. A system for domain name registrations, the system comprising:
a component configured to receive a first request to block attempts to register, with at least one domain name registry, domain names that at least partially match a string specified by the first request, the first request including mark registration information;
a component configured to validate the mark registration information;
a component configured to compare the string specified by the first request to strings specified by the mark registration information; and
a component configured to update a domain protected marks list maintained by a domain name registry to include an entry for the string specified by the first request if the string specified by the first request matches at least one of the strings specified by the mark registration information.
